(19) United States
(12) Patent Application Publication
(10) Pub. No.: US 2026/0362167 A1
(43) Pub. Date: Nov. 12, 2026

(54) CONTROL SIGNALING FOR INTEGRATED SENSING AND COMMUNICATION

(71) Applicant: MEDIATEK INC., Hsinchu City (TW)

(72) Inventors: Nathan Edward Tenny, San Jose, CA (US); Shiauhe Shawn Tsai, San Jose, CA (US); Abhishek Roy, San Jose, CA (US); Mehrdad Shariat, Cambridge (GB)

(73) Assignee: MEDIATEK INC., Hsinchu City (TW)

(21) Appl. No.: 19/474,725

(22) PCT Filed: Sep. 14, 2024
(86) PCT No.: PCT/CN2024/119013

§ 371 Date: Oct. 13, 2025

Related U.S. Application Data
(60) Provisional application No. 63/584,511, filed on Sep. 22, 2023.

(51) Int. Cl. H04W 24/02; H04W 4/38; H04W 24/10; H04W 76/20; H04W 80/02

(52) U.S. Cl. CPC H04W 24/02; H04W 4/38; H04W 24/10; H04W 76/20; H04W 80/02

(57) ABSTRACT

A method of sensing and communication includes receiving, by a sensing node, a sensing configuration request from a Sensing Function, determining, by the sensing node, to support a sensing configuration in response to the sensing configuration request, and configuring a sensing signal of the sensing node according to the sensing configuration. The method provides a comprehensive framework for realizing advanced sensing applications while minimizing the impact on communication performance and allowing for the independent evolution of sensing and communication technologies.

### CROSS REFERENCE TO RELATED APPLICATION

This application claims the benefit of U.S. Provisional Application No. 63/584,511, filed on Sep. 22, 2023. The content of the application is incorporated herein by reference.

### TECHNICAL FIELD

The present disclosure relates to wireless communications, and more specifically to methods of signaling for controlling the activity of sensing nodes in an integrated communication and sensing scheme.

### BACKGROUND

In wireless communication system, e.g., 5G or 6G cellular system, “sensing” capabilities can be integrated to detect objects that are not actively participating in the system. This means that network nodes, such as user equipment (UE) or base stations (BS), can emit signals and analyze the reflections or returned signals from objects in the environment. By processing these returned signals, the system can infer the location and other contextual information about the sensed objects. This integration of sensing capabilities into the wireless communication system is referred to as integrated sensing and communication (ISAC) or similar terms.

The current sensing systems face several critical challenges that need resolution for effective implementation. These include efficiently allocating resources between sensing and communication functions, managing mutual interference, ensuring proper coordination and synchronization among multiple nodes, addressing privacy and security concerns, designing multipurpose waveforms, balancing performance trade-offs, developing flexible network architectures, handling increased processing complexity, establishing standardization protocols, and navigating regulatory challenges. Thus, there is a need for a control signaling mechanisms that aims to address many of these issues by providing a flexible framework for managing sensing operations within communication networks. This framework would allow for dynamic resource allocation, improved coordination between nodes, and adaptable network architectures, thereby helping to resolve key ISAC challenges such as resource management, interference mitigation, and system integration.

### SUMMARY

An embodiment discloses a method of sensing and communication. The method comprises receiving, by a sensing node, a sensing configuration request from a Sensing Function, determining, by the sensing node, to support a sensing configuration in response to the sensing configuration request, and configuring a sensing signal of the sensing node according to the sensing configuration.

Another embodiment discloses a method of sensing and communication. The method comprises receiving, by a first node, a sensing configuration request from a Sensing Function, determining, by the first node, to support a sensing configuration at a second node in response to the sensing configuration request, and configuring a sensing signal of the second node according to the sensing configuration.

An embodiment discloses a user equipment (UE) comprising a sensor and a processor coupled to the sensor. The sensor is for generating a sensing signal. The processor is used to receive a sensing configuration request from a Sensing Function, determine to support a sensing configuration in response to the sensing configuration request, and configure the sensing signal according to the sensing configuration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a basic sensing operation between a sensing node and a sensing target according to the embodiments.

FIG. 2 depicts a communications system that includes a Sensing Function and multiple sensing nodes according to the embodiments.

FIG. 3 depicts protocol stacks for communication between a first sensing node and a Sensing Function located in a Core Network according to the embodiments.

FIG. 4 depicts a control-plane protocol stack for communication between a second sensing node and a Sensing Function located in a Core Network according to the embodiments.

FIG. 5 depicts a user-plane protocol stack for communication between a second sensing node and a Sensing Function located in a Data Network.

FIG. 6 depicts a flow diagram of a sequence of protocol interactions between a Sensing Function and sensing nodes according to the embodiments.

FIG. 7 depicts a communications system that includes a Sensing Function and multiple sensing nodes according to the embodiments.

FIG. 8 depicts a communications system that includes a Sensing Function and multiple sensing nodes according to the embodiments.

FIG. 9 depicts a communications system that includes a Sensing Function and multiple sensing nodes according to the embodiments.

FIG. 10 depicts a flow diagram of a sequence of protocol interactions according to the embodiments.

FIG. 11 depicts an alternative arrangement of nodes according to the embodiments.

FIG. 12 depicts an exemplary protocol stack according to the embodiments.

FIG. 13 depicts simplified block diagrams of a UE and a network entity according to the embodiments.

### DETAILED DESCRIPTION

This disclosure delves into specific details to provide a comprehensive understanding, but those skilled in the art may practice it without these specifics. Well-known methods, procedures, components, and circuits are not described in detail to maintain clarity. The disclosure primarily focuses on 3GPP wireless networks, but it can be applied to other cellular and non-cellular wireless networks.

In particular, the following technique, apparatus and system can be applied to various wireless multiple access systems. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a system, and a Single Frequency Division Multiple Access (SC-FDMA) system. Carrier Frequency Division Multiple Access) systems, and MC-FDMA (Multi-Carrier Frequency Division Multiple Access) systems. CDMA may be implemented through a radio technology such as Universal Terrestrial Radio Access (UTRA) or CDMA2000. TDMA may be implemented through a radio technology such as Global System for Mobile communications (GSM), General Packet Radio Service (GPRS), or Enhanced Data rates for GSM Evolution (EDGE). OFDMA may be implemented through a wireless technology such as Institute of Electrical and Electronics Engineers (IEEE) 802.11 (Wi-Fi), IEEE 802.16 (WiMAX), IEEE 802.20, or Evolved UTRA (E-UTRA). UTRA is part of the Universal Mobile Telecommunications System (UMTS). 3rd Generation Partnership Project (3GPP) Long-Term Evolution (LTE) is a part of Evolved UMTS (E-UMTS) using E-UTRA. 3GPP LTE uses OFDMA in downlink (DL) and SC-FDMA in uplink (UL). Evolution of 3GPP LTE includes LTE-A (Advanced), LTE-A Pro, and/or 5G New Radio (NR).

For convenience of description, the embodiment of the present specification is mainly described in relation to a 3GPP-based wireless communication system. However, the technical characteristics of the present specification are not limited thereto. For example, the following detailed description is provided based on a mobile communication system corresponding to the 3GPP-based wireless communication system, but aspects of the present specification that are not limited to the 3GPP-based wireless communication system may be applied to other wireless communication systems.

As described by the 3GPP, different wireless communication systems standards and protocols can use various radio access networks (RANs) for communicating between a base station of the RAN (which may sometimes be referred to generally as a RAN node, a network node, or simply a node) and a wireless communication device known as user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN). The RAN can include base stations (cell sites), radio equipment controllers (RECs) and fronthaul and backhaul networks to transport data between base stations, RECs, and the core network.

The RAN can include one or more access nodes, which may be referred to as base station, NodeB, evolved NodeB (eNB), next Generation NodeB (gNB), 6G nodes, RAN nodes, controllers, transmission reception points (TRPs), and so forth, and can include ground stations (e.g., terrestrial access points) or satellite stations providing signal coverage within a geographic area (e.g., a cell). The RAN may include one or more RAN nodes for providing macrocells, picocells, femtocells, or other types of cells. A macrocell may cover a relatively large geographic area (e.g., several kilometers in radius) and may allow unrestricted access by UEs with service subscription. A picocell may cover a relatively small geographic area and may allow unrestricted access by UEs with service subscription. A femtocell may cover a relatively small geographic area (e.g., a home) and may allow restricted access by UEs having an association with the femtocell (e.g., UEs in a Closed Subscriber Group (CSG), UEs for users in the home, etc.).

A base station used by a RAN may correspond to that RAN. An example of an E-UTRAN base station is an Evolved Universal Terrestrial Radio Access Network (E-UTRAN) Node B (also referred to as evolved Node B, enhanced Node B, eNodeB, or eNB). Another example of an NG-RAN base station is a next generation Node B (also referred to as a gNodeB or gNB).

A RAN provides its communication services with external entities through its connection to a core network (CN). For example, E-UTRAN may utilize an Evolved Packet Core.

Each RAN may use one or more radio access technologies (RATs) to perform communication between the base station and the UE. For example, the GERAN implements GSM and/or EDGE RAT, the UTRAN implements UMTS RAT or other 3GPP RAT, the E-UTRAN implements LTE RAT (sometimes referred to as LTE), and NG-RAN implements NR RAT (sometimes referred to as 5G RAT, 5G NR RAT, or NR). In certain deployments, the E-UTRAN may also implement NR RAT. In certain deployments, NG-RAN may also implement LTE RAT.

For terms and techniques not specifically defined or described, reference may be made to wireless communication standard documents (e.g., 3GPP Specifications) issued before this specification.

It should be noted that the use of 5G terminology throughout this discussion is not limiting, and alternative names may be used for nodes and/or interfaces that serve similar purposes.

In an ISAC system, any node with the ability to transmit and receive radio signals can function as a sensing node, such as a UE or a BS, or both (combination of a UE and a BS). These nodes can configure the sensing signals in various ways, taking into account factors like their own communication needs, the performance requirements of the sensing operation, and the characteristics of the operating radio. For example, a node focused on high-speed communication might allocate fewer resources to sensing, while high-accuracy sensing may require more bandwidth for the sensing signals. Additionally, the frequency of the sensing signals may depend on the size of the area being sensed, for example, with lower frequencies being used for larger areas due to their better propagation characteristics.

The ISAC system can employ multiple sensing nodes to combine their sensing information for various purposes. For instance, the system can use techniques like triangulation or trilateration to determine the precise location of a sensed object, referred to as a sensing target. Moreover, the system can combine data about different sensed objects to build a comprehensive model of the surrounding environment.

To manage and coordinate the ISAC operations, the system may utilize a dedicated function called a Sensing Function (SF). In certain scenarios, the SF may be combined with or considered equivalent to another function, such as a location management function (LMF), which is responsible for handling location-related tasks. The SF can be deployed at different points within the system architecture, depending on the specific requirements and design choices. For example, it can be located in the core network (CN), which is the central part of the system, or in the radio access network (RAN), which is closer to the edge and interacts directly with the user devices. In some cases, the SF can even be implemented directly on a mobile device to enable more localized and distributed sensing capabilities and/or to support sensing operation outside the coverage of a network node. However, the integration of the SF into the system introduces new challenges, particularly in terms of control signaling between the SF and the various sensing nodes. Efficient and reliable signaling mechanisms are crucial to ensure proper coordination, configuration, and operation of the Sensing Functions across the network. Therefore, developing a robust solution for control signaling between the SF and the sensing nodes is a critical requirement for the successful deployment and utilization of ISAC capabilities in 5G or potential 6G systems.

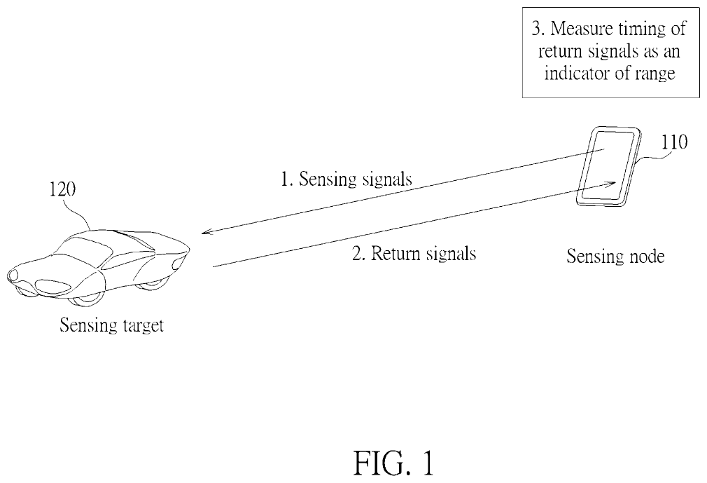

FIG. 1 depicts a basic sensing operation between a sensing node 110 and a sensing target 120 according to the embodiments. The operation includes three primary steps. Step 1 involves the transmission of sensing signals by the sensing node 110 (e.g., a user equipment). These signals may be specifically directed towards the sensing target 120 or broadcasted in a directional or omnidirectional manner. The signals that are of particular interest are those that successfully reach the sensing target 120 (e.g., a vehicle) and trigger return signals, which can be reflections of the original sensing signals.

In step 2, the sensing node 110 receives the return signals from the sensing target 120. These return signals can take various forms depending on the specific implementation. They may be simple reflections of the original signals or modified versions that have undergone amplification, modulation, or the embedding of additional information by the sensing target 120 itself.

In step 3, the sensing node 110 processes and measures different properties of the received return signals. One common measurement is the time difference between the transmission of the original sensing signals and the arrival of the corresponding return signals. This time difference can be utilized to calculate the distance or range between the sensing node 110 and the sensing target 120, based on the known propagation speed of the signals.

The capabilities of ISAC extend beyond what was previously described. In some applications, it can analyze the environment and extract various details, including the presence, location, and movement of objects. Additionally, it can determine an object's range, velocity, size, shape, and even its material properties.

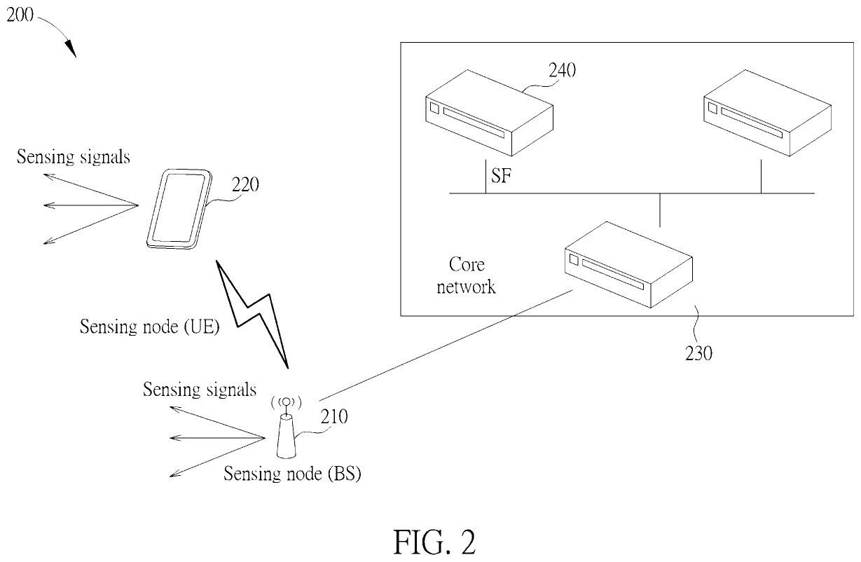

FIG. 2 depicts a communications system 200 that includes a Sensing Function (SF) 240 and multiple sensing nodes according to the embodiments. In this particular example, the SF 240 is located within the Core Network (CN) 230, although it is important to note that the SF 240 can be positioned elsewhere in the system as well.

The communications system depicted in FIG. 2 comprises an SF 240 in the CN 230, a base station (BS) 210 serving as the first sensing node, and a UE 220 serving as the second sensing node. The UE 220 and the BS 210 are connected via a wireless communication link. The BS 210 can be further connected to one or more nodes or Network Functions (NFs) in the CN 230 through a communication link, which can be wired, wireless, or a combination of both. In FIG. 2, this communication link is represented by a solid line, terminating at a specific node within the CN. This specific node may have “anchor node” functionality, similar to the Access and Mobility Management Function (AMF) in 5G systems, acting as a communication gateway between the RAN and the CN.

In certain embodiments, the BS (e.g., BS 220) can be further divided into multiple components, such as a Centralized Unit (CU) and one or more Distributed Units (DUs). The nodes within the CN (e.g., CN 230) are interconnected via a service bus, as shown in the figure. This allows CN nodes to expose and invoke services across the service bus, a mechanism known as a Service-Based Interface (SBI). In some cases, one or more RAN nodes may also communicate on the same service bus as the CN, or on a separate service bus, enabling the use of SBIs within the RAN and/or between the RAN and the CN.

It should be noted that throughout this discussion, communications can be realized in different ways: as messages of a protocol on a reference point, as invocations of an Application Programming Interface (API) on an SBI, or a combination of both. In other words, the communication link between the BS and the CN can be implemented as either a point-to-point interface or a service-based reference point over an SBI, or a combination of the two. The combination of interfaces enables communication between the sensing nodes and other nodes in the system, particularly allowing the sensing nodes to exchange information with the SF.

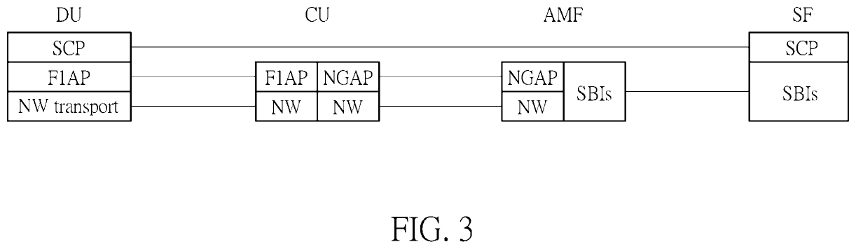

FIG. 3 depicts protocol stacks for communication between a first sensing node (in this case, a DU of a BS) and a Sensing Function (e.g., SF 240) located in a Core Network (e.g., CN 230) according the embodiments. The figure uses 5G terminology for certain nodes and interfaces, but it should be appreciated that other terminology may be used for similar functionality in a 6G system, for example. The diagram focuses on a specific portion of the communication system (e.g., communication system 200), which includes a Distributed Unit (DU), a Centralized Unit (CU), an AMF, and an SF. The communication between the DU and the SF is facilitated by a newly introduced Sensing Control Protocol (SCP), which is established between these two entities.

The DU and the CU communicate over an F1 interface using the F1 Application Protocol (F1AP). This protocol is carried over network transport layers that may vary depending on the specific implementation, denoted as “NW transport” and “NW” in the figure. Similarly, the CU and the AMF communicate over an NG interface (also known as the N2 interface) using the Next Generation Application Protocol (NGAP), which is also carried over implementation-dependent network transport layers. The AMF and the SF, on the other hand, communicate via a service bus using one or more SBIs.

The lower layers of the protocol stacks are responsible for providing transport for the SCP. This can be achieved, for example, by encapsulating or containerizing the SCP messages within the communications of the lower layers. It is important to note that the names used for nodes, protocols, and interfaces in this example are illustrative and may differ in other systems. In some cases, the base stations may have a “monolithic” architecture instead of being split into a CU and DUs. In such scenarios, the protocol stacks may be simpler than the one depicted in the figure. For a monolithic BS, the SCP may be carried over NGAP from the BS to the AMF. More generally, the SCP can be carried over any BS-to-CN interface between a BS and an anchor node in the CN. In essence, the SCP enables communication between the sensing node (DU) and the SF in the CN, with the lower layers of the protocol stacks providing the necessary transport mechanisms.

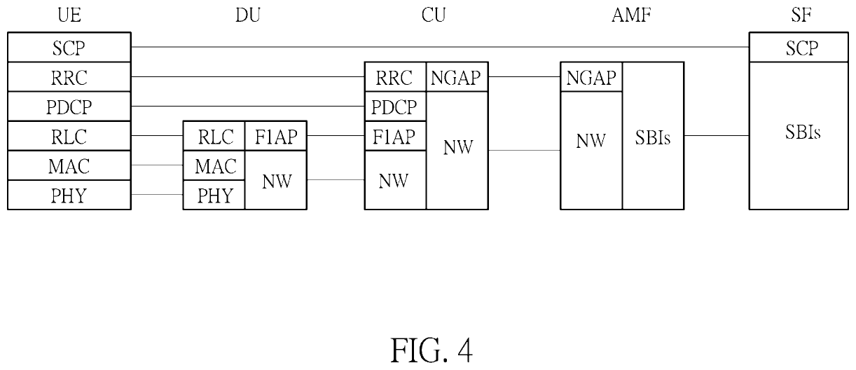

FIG. 4 depicts a control-plane protocol stack for communication between a second sensing node (e.g., UE 220) and a Sensing Function (e.g., SF 240) located in a Core Network (e.g., CN 230) according to the embodiments. The diagram focuses on a specific portion of the communication system (e.g., communication system 200), which includes a UE, a Distributed Unit (DU), a Centralized Unit (CU), an Access and Mobility Management Function (AMF), and a Sensing Function (SF). The communication between the UE (e.g., UE 220) and the SF (e.g., SF 240) is facilitated by a newly introduced Sensing Control Protocol (SCP), which is established between these two entities (i.e., UE and SF).

The UE and the DU communicate over an air interface using one or more protocol layers, such as the Radio Link Control (RLC) layer, the Medium Access Control (MAC) layer, and the Physical (PHY) layer. The DU and the CU, on the other hand, communicate over an F1 interface using F1AP, which is carried over implementation-dependent network transport layers, denoted as “NW” in the figure. Similarly, the CU and the AMF communicate over an NG interface (also known as the N2 interface) using the Next Generation Application Protocol (NGAP), which is also carried over implementation-dependent network transport layers. The AMF and the SF communicate via a service bus using one or more Service-Based Interfaces (SBIs).

Although the UE and the CU do not have direct communication on a specific interface, they mutually communicate over one or more protocol layers, such as the Radio Resource Control (RRC) layer and the Packet Data Convergence Protocol (PDCP) layer. The lower layers of the protocol stacks are responsible for providing transport for the SCP, which can be achieved by encapsulating or containerizing the SCP messages within the communications of the lower layers. In essence, the SCP enables communication between the sensing node (i.e., UE) and the SF in the CN, with the lower layers of the protocol stacks providing the necessary transport mechanisms.

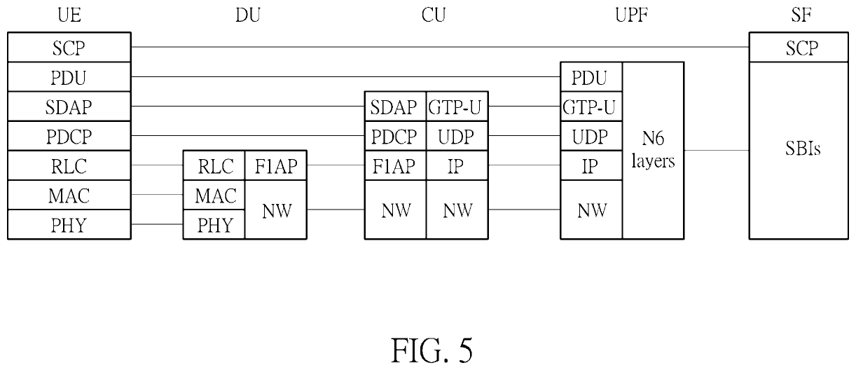

FIG. 5 depicts a user-plane protocol stack for communication between a second sensing node (e.g., UE 220) and a Sensing Function (e.g., SF 240) located in a Data Network (DN). The diagram focuses on a specific portion of the communication system (e.g., communication system 200), which includes a UE, a Distributed Unit (DU), a Centralized Unit (CU), a User Plane Function (UPF), and a Sensing Function (SF). The communication between the UE and the SF is facilitated by a newly introduced Sensing Control Protocol (SCP), which is established between these two entities (i.e., UE and SF).

The UE and the DU communicate over an air interface using one or more protocol layers, such as the Radio Link Control (RLC) layer, the Medium Access Control (MAC) layer, and the Physical (PHY) layer. The DU and the CU communicate over an F1 interface using FIAP, which is carried over implementation-dependent network transport layers, denoted as “NW” in the figure. The CU and the UPF communicate over an N3 interface using the GPRS Tunneling Protocol for the User Plane (GTP-U), which is transported over a User Datagram Protocol (UDP) layer, an Internet Protocol (IP) layer, and implementation-dependent network transport layers.

The UPF and the SF communicate over an N6 interface via the DN, using transport layers that are not detailed in the figure. Alternatively, the UPF and the SF may communicate over Service-Based Interfaces (SBIs) within the Core Network (CN). The UE and the CU mutually communicate over one or more protocol layers, such as the Service Data Application Protocol (SDAP) layer and the Packet Data Convergence Protocol (PDCP) layer. The UE and the UPF mutually communicate over a Protocol Data Unit (PDU) layer.

In certain embodiments, the SF can be considered as an application server in the DN, and the UPF can act as a gateway between the nodes of the cellular network and the DN. In this case, the SCP is carried between the UE and the SF as user-plane data.

This user-plane protocol stack enables the communication between the sensing node (UE) and the SF in the DN, with the lower layers of the stack providing the necessary transport mechanisms. The specific arrangement of nodes and interfaces allows for the seamless integration of the Sensing Function into the existing cellular network architecture.

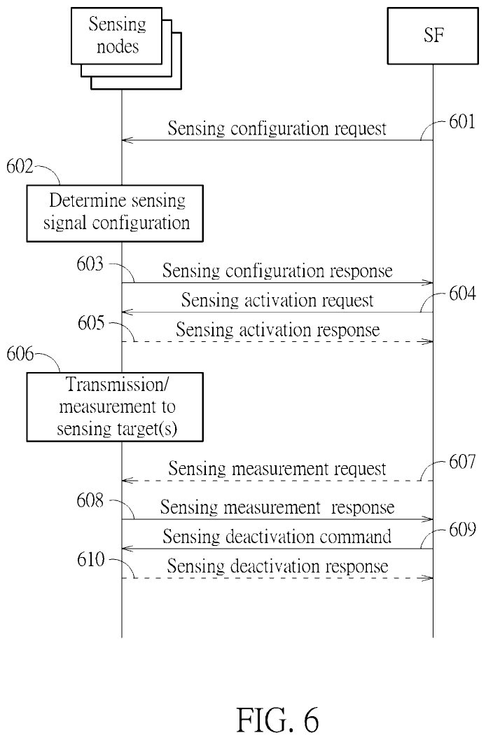

FIG. 6 depicts a flow diagram of a sequence of protocol interactions between a Sensing Function (SF) and sensing nodes according to the embodiments. The communications shown in the FIG. 6 can be either messages of a Sensing Control Protocol (SCP) or invocations of a Service-Based Interface (SBI). These communications may use various protocol stacks for transport, such as those shown in the previous figures or similar protocol stacks with different terminology. Also, it should be noted that the optional steps are illustrated by dashed arrows.

The sequence begins with the SF (e.g., SF 240) determining that a sensing operation is required. In step 601, the SF sends a sensing configuration request to the sensing nodes (e.g., BS 210 and/or UE 220), which may initiate a first SCP transaction. This request may include desired characteristics of the sensing signal configuration (hereinafter referred to as “sensing configuration”). Although depicted as a single message, the request may comprise multiple messages sent separately to different sensing nodes. In some cases, the sensing configuration (or a part of it) may be delivered to the sensing nodes over the control plane via existing N1 or N2 interfaces or equivalent service-based reference points, as policies for the UE and/or the BS.

In step 602, each sensing node determines a sensing configuration it will support, considering factors such as its radio capabilities, requirements for transmissions of other RF signals, expected controlling interference on the air interface, and the characteristics of the requested sensing configuration (e.g., radio frequency, timing, power, etc.). In step 603, the sensing nodes then respond to the SF with a sensing configuration response, concluding the first SCP transaction.

Next, the SF sends a sensing activation request to the sensing nodes in step 604 to cause the sensing node to start transmitting sensing signals, thereby starting a second SCP transaction. In step 605, the sensing nodes may optionally respond with a sensing activation response, which may be omitted if the activation of a previously confirmed configuration is considered fail-proof. If step 605 is performed, it concludes the second SCP transaction.

In step 606, the sensing nodes perform transmission and measurement of sensing signals to sensing targets, following procedures similar to those described in FIG. 1.

Optionally, the SF may send a sensing measurement request to the sensing nodes, in step 607, initiating a third SCP transaction, if the sensing activation request in step 604 does not include a request for measurements.

The sensing nodes send a sensing measurement report to the SF in step 608, providing the information obtained from the measurements in step 606. Depending on whether step 607 occurred, this report (in step 608) may conclude the third SCP transaction, initiate a new SCP transaction, or conclude the second SCP transaction.

In step 609, the SF sends a sensing deactivation command to the sensing nodes, instructing them to stop transmitting sensing signals. The sensing nodes may optionally send a sensing deactivation response in step 610, confirming the deactivation of the sensing signals. In some cases, step 610 may be omitted if deactivation is considered fail-proof.

Finally, the SF evaluates the reported sensing measurements, applies implementation-specific criteria and heuristics, and draws inferences about the sensing targets.

In certain embodiments, the SF may employ different protocols when communicating with different types of sensing nodes. For instance, the SF may use a first sensing control protocol (SCP1) when interacting with a sensing node embodied in a UE; the SF may use a second sensing control protocol (SCP2) when communicating with a sensing node embodied in a BS. Although these protocols may have similar messages and functionality, they are formally considered to have different termination points.

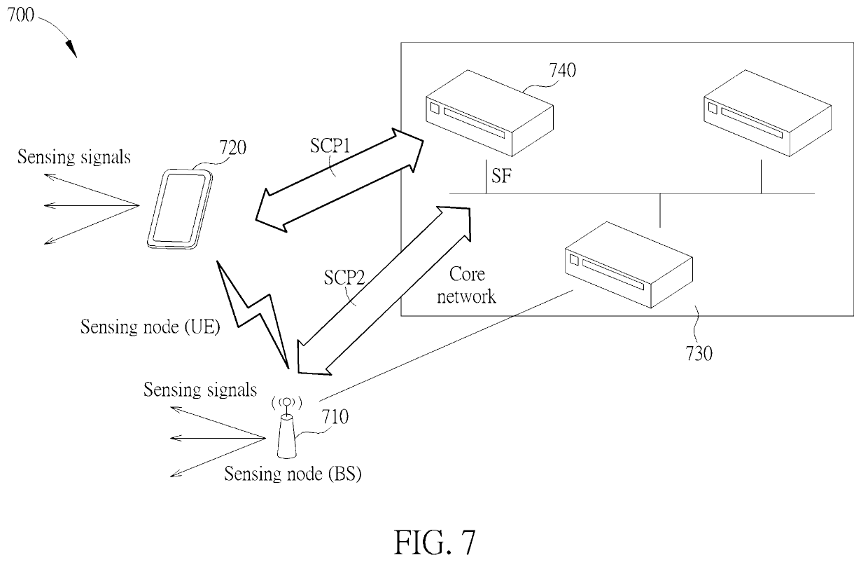

FIG. 7 depicts a communications system 700 that includes a Sensing Function and multiple sensing nodes according to the embodiments. In this illustration, the SF 740, shown as an element of the Core Network (CN) 730, uses SCPI to communicate with a sensing node embodied in a UE 720 and SCP2 to communicate with a sensing node embodied in a BS 710. The protocol layering for the transport of SCP1 and SCP2 may be similar to the protocol stacks illustrated in FIGS. 3, 4, and 5.

This approach allows the SF 740 to tailor its communication protocols to the specific requirements and capabilities of different types of sensing nodes. By using separate protocols for the UE 720 and the BS 710, the system can accommodate the unique characteristics and constraints of each type of sensing node while maintaining a consistent set of messages and functionality across the protocols. This flexibility enables the SF 740 to efficiently manage and coordinate the sensing activities of a diverse set of sensing nodes within the network.

In some scenarios, different protocols may be used between different endpoints to carry a common SCP. For instance, a SF may communicate with a sensing node embodied in a UE using a first Sensing Transport Protocol STP1 and with a sensing node embodied in a BS using a second Sensing Transport Protocol STP2, with each of STP1 and STP2 carrying messages of SCP.

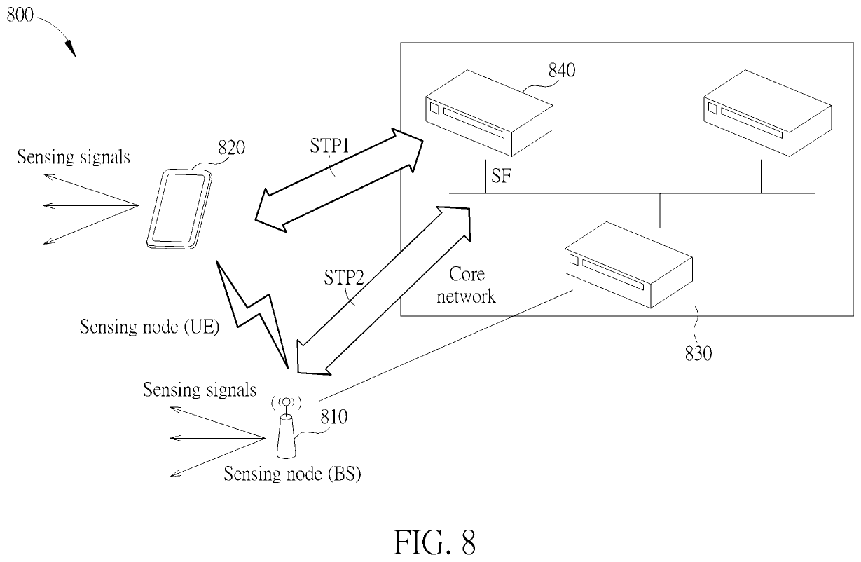

FIG. 8 depicts a communications system 800 that includes a Sensing Function and multiple sensing nodes according to the embodiments. In this embodiment, the SF 840, shown as an element of the CN 830, uses a single SCP for communication with sensing nodes embodied in both a BS 810 and a UE 820. However, the SF employs the first Sensing Transport Protocol STP1 for communication with the sensing node embodied in the UE 820 and the second Sensing Transport Protocol STP2 for communication with the sensing node embodied in the BS 810.

In this illustration, the Sensing Transport Protocols STP1 and STP2 may be protocols of limited scope that include “container” messages. These messages may contain a transparent container field capable of encapsulating an SCP message. Such a container field can be implemented using various data types, such as a BIT STRING or OCTET STRING, in an Abstract Syntax Notation One (ASN.1) message format.

The above-described arrangement offers several advantages. It allows for the definition and maintenance of a single SCP that includes the substantive messages needed for controlling the sensing activities. At the same time, it enables separate maintenance of the transport protocols that communicate over different network nodes. This approach provides flexibility in adapting the transport protocols to the specific requirements and constraints of different types of sensing nodes while maintaining a consistent set of control messages across the system.

By decoupling the transport protocols from the SCP, this design facilitates the evolution and optimization of the sensing control messaging independently of the transport mechanisms. This can lead to a more modular, scalable, and maintainable architecture for the sensing control system within the network.

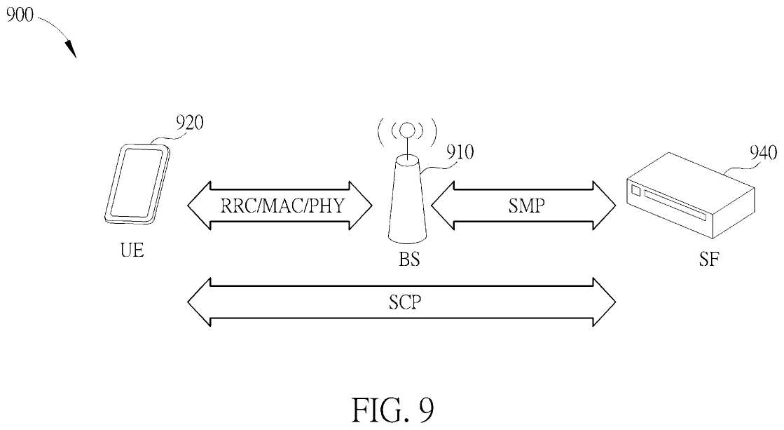

FIG. 9 depicts a communications system 900 that includes a Sensing Function and multiple sensing nodes according to the embodiments.

In some cases where the sensing node is a UE 910, the control of sensing functionality may need to be shared between an SF 940 and a base station (BS) 910. This scenario may happen when the signals used for sensing are under the direct control of the BS 910, and some operations on these signals, such as activation and deactivation, require low latency and thus are poorly suited for direct control by the SF 940. Moreover, the BS 910 may have a better understanding of the radio constraints that can affect the scheduling and configuration of sensing signals compared to the SF 940. Consequently, a design may be preferred in which sensing configurations for the UE 920 acting as a sensing node are negotiated between an SF and one or more BSs, with the BS 910 having direct control of the sensing signals at the UE 920.

In this setup, a Sensing Control Protocol (SCP) is used for communication between the SF 940 and the UE 920. An additional protocol, referred to as a Sensing Management Protocol (SMP), is employed for communication between the SF 940 and the BS 910. Radio protocols (e.g., RRC, MAC, or PHY) are used for communication between the BS 910 and the UE 920.

It is important to note that in FIG. 9, the BS 910 itself is not considered a sensing node. However, if BS-based sensing is also desired, the SF 940 can separately establish a control protocol (e.g., SCP) with the BS as described earlier.

This architecture allows for a clear separation of responsibilities between the SF 940 and the BS 910 in controlling the Sensing Functionality of the UE 920. The SF 940 can focus on high-level coordination and management of sensing activities across multiple nodes, while the BS 910 can handle the low-level, latency-sensitive control of sensing signals based on its knowledge of the radio environment and constraints. By leveraging the SMP between the SF 940 and the BS 910, the system can ensure that the sensing configurations for the UE are appropriately negotiated and aligned with the overall sensing objectives. At the same time, the use of radio protocols between the BS 910 and the UE 920 enables efficient and responsive control of the sensing signals, taking into account the real-time dynamics of the radio interface.

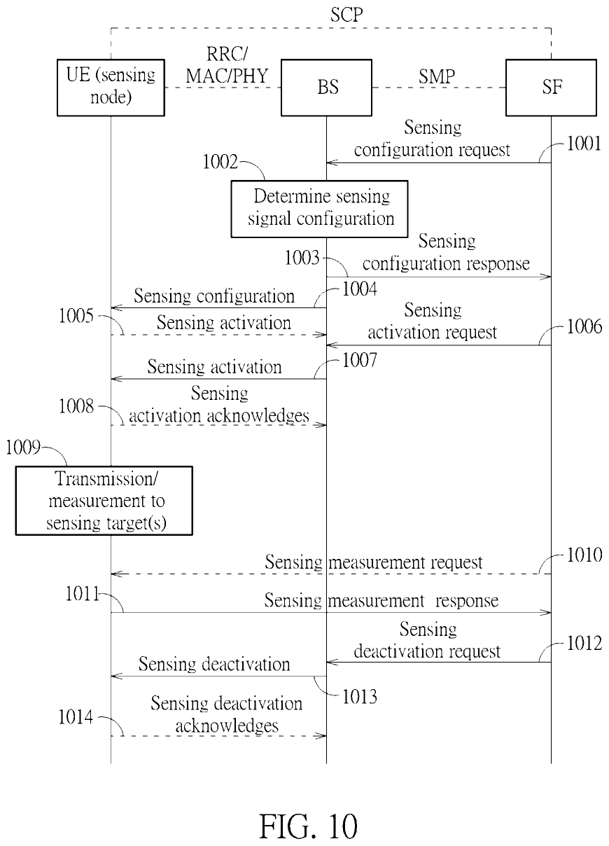

FIG. 10 depicts a flow diagram of a sequence of protocol interactions among a SF, a base station and a sensing node located at a UE, according to the embodiments. The sensing configurations are negotiated between the SF (e.g., SF 940) and the BS (e.g., BS 910), and then delivered from the BS (e.g., BS 910) to the UE (e.g., UE 920). The flow diagram of FIG. 10 is a variation of the flow diagram illustrated by FIG. 6, with the involvement of the BS. Also, it should be noted that the optional steps are illustrated by dashed arrows.

The process begins with the SF sending a sensing configuration request to the BS in step 1001, potentially specifying the desired characteristics of the sensing signal to fulfill the requirements of the underlying sensing operation. In step 1002, the BS determines the sensing configuration it can support for the UE, considering factors such as the existing signal transmission and reception configuration of the UE, coordination with other UEs in the service area of the BS, and any other implementation-specific criteria. Then, the BS sends a sensing configuration response to the SF in step 1003, indicating the selected configuration, which may differ from the requested configuration in step 1. In step 1004, the BS sends a configuration message (e.g., an RRCReconfiguration message) to the UE, specifying the sensing configuration. Next, the UE may optionally acknowledge the configuration in step 1005 (e.g., with an RRCReconfigurationComplete message), confirming its receipt and successful application. The step 1005 may be omitted if the configuration delivery is reliable and assumed to always succeed, although it can be beneficial for the BS to know when the UE has finished applying the configuration.

In step 1006, the SF sends a sensing activation request to the BS, indicating that the BS should trigger the UE to start transmitting the configured sensing signals. The BS then sends a sensing activation instruction (e.g., a MAC Control Element) to the UE in step 1007, triggering the transmission of the configured sensing signals. The activation instruction may specify which of multiple configured sensing signals should be activated. The UE may optionally acknowledge the activation in step 1008 (e.g., with an uplink MAC Control Element), confirming the requested activation. The step 1008 may be omitted if activation is assumed to always succeed and occur immediately, and the BS does not require explicit notification of acceptance. Then, the UE transmits sensing signals towards sensing targets and measures the returning signals in step 1009 (similar to step 606 in FIG. 6).

The SF may optionally send a sensing measurement request (e.g., an SCP message) to the UE in step 1010. The step 1010 may be omitted if the UE is aware of the involved SF and the activation in step 1007 implicitly instructs the UE to return measurements to the SF. However, if the SF has multiple algorithms requiring different measurements, step 1010 may be necessary to indicate which measurements should be reported. The step 1010 can be performed in an asynchronous manner with steps 1007-1009, as the SF may request measurements anytime after the activation request in step 1006, and the UE would only return measurements once it has activated sensing signals and performed the requested measurements. In some cases, step 1010 may precede step 1009, allowing the UE to consider the request from the SF when determining which signal characteristics (e.g., timing, angle, and phase) to measure.

The UE sends a sensing measurement report (e.g., an SCP message) to the SF in step 1011, including information measured from the returned signals in step 1009. When the SF determines it has collected the necessary measurements, it sends a sensing deactivation request to the BS in step 1012. The BS then sends a sensing deactivation instruction (e.g., a MAC Control Element) to the UE in step 1013, indicating that the UE should stop transmitting the configured sensing signals. The UE may optionally acknowledge the deactivation in step 1014, which may be omitted if deactivation cannot fail or no subsequent operation depends on the deactivation timing.

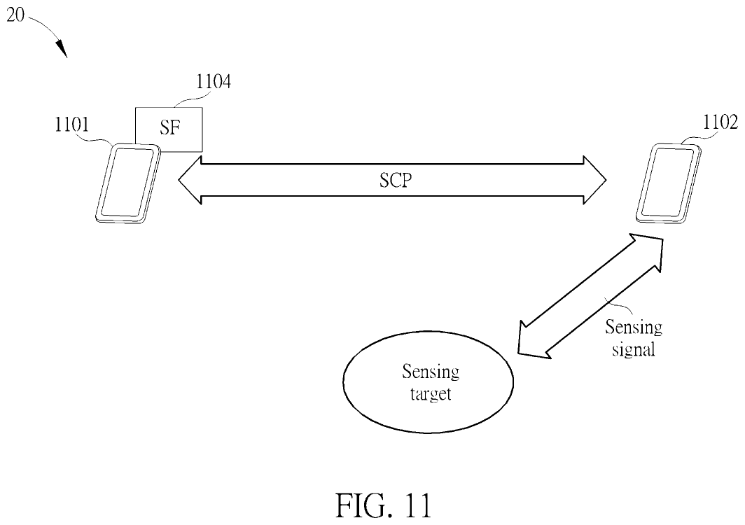

FIG. 11 depicts an alternative arrangement of nodes according to the embodiments. In this arrangement, the SF 1104 is integrated in a first UE 1101 rather than in the network. In this example, the SF 1104 is hosted by the first UE 1101, while a second UE 1102 serves as a sensing node. A control protocol, such as the SCP, is used for communication between the first UE 1101 (hosting the SF 1104) and the second UE 1102 (acting as the sensing node). This control protocol is responsible for controlling the operation of the second UE, instructing it to transmit sensing signals and measure the returning signals from a sensing target.

The functionality of this arrangement is similar to the previously described cases where the SF is integrated in the network node. However, the transport protocols used to carry the SCP messages may differ. When the SF 1104 is hosted by the UE 1101, the SCP messages may be transported using protocols specifically designed for UE-to-UE communication, such as those used in device-to-device (D2D) or sidelink communication scenarios.

In certain embodiments, the SF 1104 hosted on the first UE 1101 may communicate with an SF located in the Core Network (CN) to support the sensing functionality. This communication between the UE-based SF (e.g., SF 1104) and the CN-based SF may be necessary for coordination, synchronization, or exchange of information related to the sensing operation. The exact nature of this communication and the protocols used may depend on the specific implementation and the division of responsibilities between the UE-based and CN-based SFs.

In certain embodiments, the SF 1104 hosted on the first UE 1101 may support the sensing functionality independently, without any coordination with the CN. In such cases, the UE-based SF (e.g., SF 1104) may have all the necessary information, algorithms, and decision-making capabilities to manage the sensing operation on its own. The autonomous operation may be suitable for scenarios where the sensing is localized and does not require network-wide coordination, or where the UEs are operating in an ad-hoc manner without a reliable connection to the network infrastructure.

The choice between these two approaches (coordination with the CN-based SF or autonomous operation) may depend on various factors, such as the specific use case, the scale and complexity of the sensing operation, the available network resources, and the desired level of control and centralization.

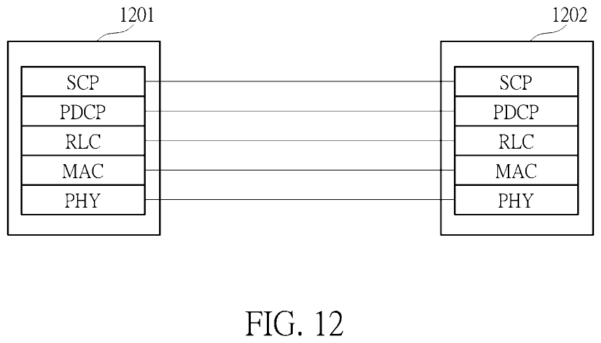

FIG. 12 depicts exemplary protocol stacks according to the embodiments. The protocol stacks are used for transporting the SCP between two UEs 1201 and 1202 in a 5G system. In this example, the first UE 1201 and the second UE 1202 communicate using the SCP, which is carried directly over the Packet Data Convergence Protocol (PDCP) layer.

However, in certain embodiments, the SCP may be encapsulated within an intermediate control protocol layer, such as the PC5 Radio Resource Control (PC5-RRC) protocol, the PC5 Signaling (PC5-S) protocol, or similar control protocols specifically designed for D2D communication interfaces.

In the given example, the PDCP layer sits on top of the RLC layer, which in turn is above the MAC layer. The MAC layer is then positioned above the PHY layer. This arrangement of protocol layers follows the typical structure of a D 2D protocol stack in 5G systems.

In certain embodiments, the D2D protocol stack may include different layers or a different organization of layers compared to the example shown in FIG. 12. Regardless of the specific structure, the central concept is that the SCP can be carried over the upper layers of any such D2D protocol stack.

The use of the D2D protocol stack allows the SCP to be efficiently transported between UEs 1201 and 1202 without the need for intermediate network nodes. This direct UE-to-UE communication enables fast and low-latency exchange of sensing control information, which is crucial for coordinating and synchronizing the sensing operations between the UEs. It is also noted that D2D communication may allow support of sensing operation when one or more involved UEs are out of coverage of a network node.

By leveraging the existing 5G D 2 D protocol layers, such as PDCP, RLC, MAC, and PHY, the SCP can benefit from the reliable and secure communication mechanisms provided by these layers. This ensures that the sensing control messages are delivered accurately and in a timely manner, enabling effective collaboration between the UEs for sensing purposes.

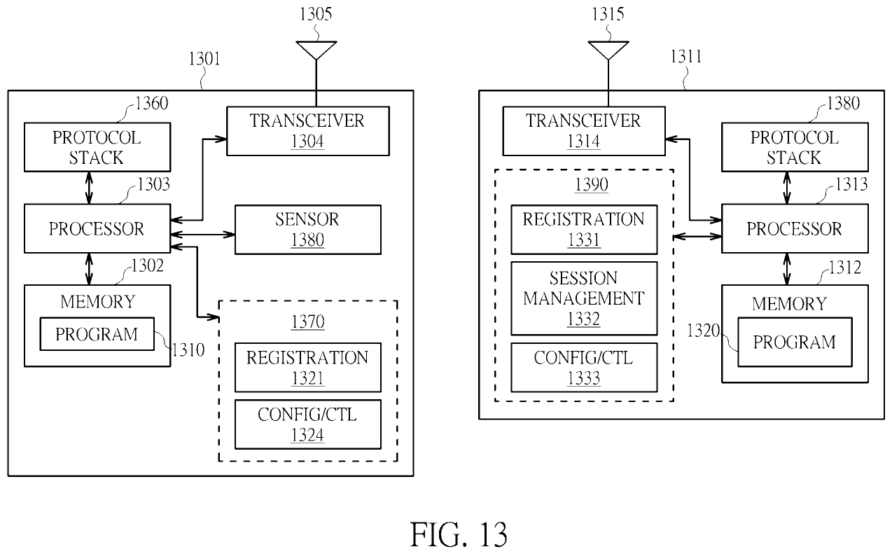

FIG. 13 depicts simplified block diagrams of a UE 1301 and a network entity 1311 according to the embodiments. The network entity 1311, which may be integrated into a base station, is equipped with an antenna 1315 for transmitting and receiving radio signals. The antenna is connected to a RF transceiver module 1314, which converts received RF signals to baseband signals and sends them to a processor 1313. The transceiver also converts baseband signals from the processor back to RF signals for transmission via the antenna. The processor 1313 processes the baseband signals and invokes various functional modules to perform the features of the base station 1311. The memory 1312 stores program instructions and data 1320 to control the operations of the base station. Additionally, the network entity 1311 includes a set of control functional modules and circuit 1390, such as a registration circuit 1331 for handling registration and mobility procedures, a session management circuit 1332 for managing sessions, and a configuration and control circuit 1333 for providing configuration and control parameters to the UEs.

Similarly, the UE 1301 comprises a memory 1302, a processor 1303, and a RF transceiver module 1304 connected to an antenna 1305. The RF transceiver converts received RF signals to baseband signals for the processor and converts baseband signals from the processor to RF signals for transmission. The processor 1303 processes the baseband signals and invokes various functional modules and circuits to perform UE features. The memory 1302 stores data and program instructions 1310 for execution by the processor to control UE operations. Suitable processors include special purpose processors, digital signal processors (DSPs), microprocessors, microcontrollers, application-specific integrated circuits (ASICs), field programmable gate arrays (FPGAs), and other types of integrated circuits (ICs) or state machines. A processor associated with software can be used to implement and configure the UE 1301 features.

The UE 1301 also includes a set of functional modules and control circuits for performing UE tasks. The protocol stacks 1360 may include a SCP layer for communicating with the Sensing Function in the core network, a RRC layer for high-layer configuration and control, a PDCP layer, an RLC layer, a MAC layer, and a PHY layer. A system modules and circuits 1370, implemented and configured by software, firmware, hardware, or a combination thereof, interwork with each other to enable UE 1301 to perform embodiments and functional tasks and features in the network. These modules include a registration circuit 1321 for performing registration and mobility procedures, and a configuration and control circuit 1324 for handling configuration and control parameters. The UE 1311 also includes a sensor 1380 for transmitting the sensing signal to a sensing target and measuring a returned signal reflected from the sensing target. Then, the processor 1303 can generate a measurement report accordingly. Examples of sensors include laser altimeters, LiDAR, radar, ranging instruments, and scatterometers, infrared sensors, multispectral sensors, radiometers, microphone and cameras. It should be noted that the sensor 1380 includes active sensors, which involve both the transmission of sensing signals and the measurement of their reflections or returns.

The disclosed ISAC control signaling mechanism provides a flexible, scalable, and efficient framework for integrating sensing capabilities into wireless communication networks. By using a dedicated SCP, the system enables the SF to be located in various parts of the network, such as the core network, radio access network, or even in user equipment. This flexibility allows the system to adapt to different network architectures and use cases while promoting interoperability between different vendors. The control signaling enables the SF to negotiate and configure sensing parameters based on specific task requirements, optimizing radio resource allocation and minimizing the impact on communication performance. For UE-based sensing, the split between the SF and the base station allows for fast and responsive control of time-critical operations, which is crucial for real-time sensing applications. The modular approach of the control signaling separates sensing-specific functionality from the underlying communication protocols, facilitating independent evolution and optimization of sensing and communication aspects. Furthermore, the control signaling enhances coordination across multiple nodes, enabling collaborative sensing techniques that improve accuracy, reliability, and coverage of sensing results. Overall, the disclosed ISAC control signaling mechanism provides a comprehensive framework for realizing advanced sensing applications while minimizing the impact on communication performance and allowing for the independent evolution of sensing and communication technologies.

User equipment (UE) as described in this disclosure may include a device with radio communication capabilities. For example, the UE may include a smartphone (e.g., handheld touchscreen mobile computing devices connectable to one or more cellular networks). The UE may also include any mobile or non-mobile computing device, such as Personal Data Assistants (PDAs), pagers, laptop computers, desktop computers, wireless handsets, or any computing device that has a wireless communications interface.

The UE may also be referred to as a client, mobile device, mobile terminal, user terminal, mobile unit, mobile station, mobile user, subscriber, user, remote station, access agent, user agent, receiver, radio equipment, reconfigurable radio equipment, or reconfigurable mobile device. The UE may include IoT UE, which can include a network access layer designed for low-power IoT applications utilizing short-lived UE connections. IoT UE can utilize technologies (e.g., M2M, MTC, or mMTC technology) for exchanging data with an MTC server or device via a PLMN, other UEs using ProSe or D2D communications, sensor networks, or IoT networks. The M2M or MTC exchange of data may be a machine-initiated exchange of data. An IoT network describes interconnecting IoT UE, which may include uniquely identifiable embedded computing devices (within the Internet infrastructure). The IoT UE may execute background applications (e.g., keep-alive messages, status updates, etc.) to facilitate the connections of the IoT network.

Furthermore, the UE may be configured to connect or communicatively couple with the Radio Access Network (RAN) through a radio interface, which may be a physical communication interface or layer configured to operate with cellular communication protocols such as a GSM protocol, a CDMA network protocol, a Push-to-Talk (PTT) protocol, a PTT over Cellular (POC) protocol, a UMTS protocol, a 3GPP LTE protocol, a 5G protocol, a NR protocol, and the like. For example, the UE and the RAN may use a Uu interface (e.g., an LTE-Uu interface) to exchange control plane data via a protocol stack comprising a PHY layer, an MAC layer, an RLC layer, a PDCP layer, and an RRC layer. A DL transmission may be from the RAN to the UE and a UL transmission may be from the UE to the RAN. The UE may further use a sidelink to communicate directly with another UE (not shown) for D2D, P2P, and/or ProSe communication. For example, a ProSe interface may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The terminology used in the description of the various described embodiments (or implementations) herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

Terms such as “coupled,” “connected,” “connecting,” and “electrically connected” are used synonymously to describe the state of being electrically or electronically linked. Likewise, when one entity is said to be in “communication” with another entity or entities, it means that the first entity is capable of sending and/or receiving electrical signals, which may contain voice or non-voice data/control information, to or from the second entity, irrespective of the analog or digital nature of the signals.

The various illustrative logical blocks, modules, functions, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects described herein can be implemented in both hardware and software instructions. These instructions may be stored on various types of computer-readable media, such as Random Access Memory (RAM), flash memory, Read Only Memory (ROM), Electrically Programmable ROM (EPROM), Electrically Erasable Programmable ROM (EEPROM), registers, hard disks, removable disks, CD-ROMs, or any other form of storage medium known in the art. In a typical setup, the storage medium is connected to the processor, allowing the processor to read from and write to the medium. Alternatively, the storage medium may be built into the processor itself. Both the processor and the storage medium may reside within an ASIC, which can be located in a remote station. In another configuration, the processor and the storage medium may exist as separate components within a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

In some embodiments, the computing instructions may be carried out by an operating system, for example, Microsoft Windows, Apple Mac OS X, macOS, or iOS operating systems, some variety of the Linux operating system, Google Android operating system, or the like.

In some embodiments, the computers may be on a distributed computing network, such as one having any number of clients and/or servers. Each client may run software for implementing client-side portions of the embodiments. In addition, any number of servers may be provided for handling requests received from one or more clients. Clients and servers may communicate with one another via one or more electronic networks, which may be in various embodiments such as the Internet, a wide area network, a mobile telephone network, a wireless network (e.g., Wi-Fi, 5G, and so forth), or a local area network. Networks may be implemented using any known network protocols.

For situations in which the systems discussed above collect information about users, the users may be provided with an opportunity to opt in/out of programs or features that may collect personal information (e.g., information about a user's preferences or usage of a smart device). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

While some embodiments comprise the disclosed features and may therefore include additional features not specifically described, other embodiments may be essentially free of or completely free of non-disclosed elements. That is, non-disclosed elements may optionally be essentially omitted or completely omitted.

Although some of the drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The drawings illustrate embodiments or implementations that have been described in detail, with numerous specific details provided to ensure a comprehensive understanding of these embodiments. However, it will be evident to a person skilled in the art that the described embodiments can be practiced without relying on these specific details. In some cases, well-known methods, procedures, components, circuits, and networks have been mentioned without elaborate explanation to avoid unnecessarily obscuring aspects of the embodiments. Furthermore, it is important to note that the various figures, including component diagrams, presented and discussed herein are intended for illustrative purposes only and are not necessarily drawn to scale.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of sensing and communication, comprising:
receiving, by a sensing node, a sensing configuration request from a Sensing Function;
determining, by the sensing node, to support a sensing configuration in response to the sensing configuration request; and
configuring a sensing signal of the sensing node according to the sensing configuration.

2. The method of claim 1, further comprising:
sending a sensing configuration response from the sensing node to the Sensing Function;
receiving, by the sensing node, a sensing activation request from the Sensing Function; and
activating the sensing configuration to trigger the transmission of the sensing signal by the sensing node according to the sensing activation request.

3. The method of claim 2, further comprising receiving, by the sensing node, a sensing measurement request from the Sensing Function to trigger the sensing node to perform a measurement.

4. The method of claim 2, further comprising transmitting the sensing signal from the sensing node to a sensing target and measuring a returned signal reflected from the sensing target to generate a measurement report.

5. The method of claim 4, further comprising sending the measurement report from the sensing node to the Sensing Function.

6. The method of claim 2, further comprising:
receiving, by the sensing node, a sensing deactivation command from the Sensing Function to deactivate the sensing configuration; and
ending transmission of the sensing signal by the sensing node according to the sensing deactivation command.

7. The method of claim 1, wherein the sensing configuration request is a radio resource control (RRC) message or a medium access control (MAC) control element (CE).

8. A method of sensing and communication, comprising:
receiving, by a first node, a sensing configuration request from a Sensing Function;
determining, by the first node, to support a sensing configuration at a second node in response to the sensing configuration request; and
configuring a sensing signal of the second node according to the sensing configuration.

9. The method of claim 8, further comprising sending a configuration message from the first node to the second node.

10. The method of claim 9, wherein the configuration message is a radio resource control (RRC) message or a medium access control (MAC) control element (CE).

11. The method of claim 8, further comprising:
receiving, by the first node, a sensing activation request from the Sensing Function;
sending a sensing activation instruction from the first node to the second node according to the sensing activation request; and
triggering a transmission of the sensing signal at the second node according to the sensing activation instruction.

12. The method of claim 11, wherein the sensing activation instruction is an RRC message or a MAC CE.

13. The method of claim 11, further comprising receiving, by the second node, a sensing measurement request from the Sensing Function.

14. The method of claim 11, further comprising transmitting the sensing signal from the second node to a sensing target and measuring a returned signal reflected from the sensing target to generate a measurement report.

15. The method of claim 14, further comprising sending the measurement report from the second node to the Sensing Function to trigger the second node to perform a measurement.

16. The method of claim 11, further comprising:
receiving, by the first node, a sensing deactivation request from the Sensing Function;
sending a sensing deactivation instruction from the first node to the second node according to the sensing deactivation request; and
ending the transmission of the sensing signal by the second node according to the sensing deactivation instruction.

17. The method of claim 16, wherein the sensing deactivation instruction is an RRC message and/or a MAC CE.

18. The method of claim 8, wherein the first node and/or the second node comprises a Sensing Function.

19. The method of claim 8, wherein the first node is a base station (BS), and the second node is a user equipment (UE).

20. A user equipment (UE) comprising:
a sensor for generating a sensing signal; and
a processor coupled to the sensor, configured to:
receive a sensing configuration request from a Sensing Function;
determine to support a sensing configuration in response to the sensing configuration request; and
configure the sensing signal according to the sensing configuration.
